(19) United States
(12) Patent Application Publication
(10) Pub. No.: US 2025/0216696 A1
(43) Pub. Date: Jul. 3, 2025

(54) EYEWEAR

(71) Applicant: JINS HOLDINGS Inc., Gunma (JP)

(72) Inventor: Yasunori KITAGAITO, Gunma (JP)

(73) Assignee: JINS HOLDINGS Inc., Gunma (JP)

(21) Appl. No.: 19/002,367

(22) Filed: Dec. 26, 2024

(30) Foreign Application Priority Data
Dec. 28, 2023 (JP) 2023-222752

(51) Int. Cl. G02C 5/14; G02C 5/22

(52) U.S. Cl. CPC G02C 5/14; G02C 5/2272

(57) ABSTRACT

Provided is a hingeless eyewear in which, in a case where a pair of temples is locked to each other and folded, it is possible to prevent one temple from being unintentionally disengaged from the other temple.

An eyewear 1 includes a front 10 and a pair of temples 11 connected to the front 10 in a hingeless manner. A front region 50 of each of the temples 11 has a protrusion portion 60 that protrudes in an inner direction of the temple 11. A rear region 51 has a groove portion 80 that penetrates the temple 11 in an in-out direction and a recess portion 81 that is disposed on an outer side surface of the temple 11 and communicates with the groove portion 80. The pair of temples 11 is configured such that the groove portion 80 of one temple 11 is fitted into a portion of the front region 50 of the other temple 11 that is closer to a front 10 side than the protrusion portion 60 and is further slid along the front region 50 to a protrusion portion 60 side, so that the protrusion portion 60 of the other temple 11 is accommodated in the recess portion 81 of the one temple 11.

### BACKGROUND

### Field

The present invention relates to an eyewear.

### Description of Related Art

In the related art, there is a so-called hingeless eyewear in which a screw is not used at a joint between a front and a temple (see Japanese Patent Application Laid-Open No. 2015-191231, Japanese Registered Utility Model No. 3204319, and Japanese Patent Application Laid-Open No. 2013-97102). These hingeless eyewear have a structure in which a rear region portion of one temple is hooked to a front region portion of the other temple so that the temple is able to be folded.

### SUMMARY

However, in the above-described hingeless eyewear, only a groove portion that is provided at a temple tip distal end of the rear region of one temple and that penetrates in temple tip in-out directions is locked from above to the front region portion of the other temple, and in terms of structure, there is a concern that when an external force is applied upward to the temple tip distal end and a locking portion of the temple, a temple folded state may be easily released by disengagement of the locking. In addition, in these hingeless eyewear, a decoration or a ring joint structure is provided in the front region portion of the other temple, and thus, a characteristic design is presented in appearance, which imposes a design constraint for consumers who prefer a simple hingeless eyewear.

The present invention has been made in view of such points, and when a pair of temples of the hingeless eyewear is locked to each other and folded, it is possible to prevent that one temple is unintentionally disengaged from the other temple, and particularly, when an external force is applied to the locking portion in an up or down direction, it is possible to prevent that the temple folded state is easily released by disengagement of the locking. Further, an object is to provide a hingeless eyewear having a sophisticated design with a simple and natural shape in which a locking structure between the temples is not likely to be conspicuous.

An eyewear according to an aspect of the present invention includes a front; and a pair of temples connected to the front in a hingeless manner not to include a hinge structure, the hinge structure having a rotation axis, and the pair of temples having flexibility, in which each of the temples has a front region on a front side and a rear region on a rear end side opposite to the front side, the front region has a protrusion portion that protrudes in at least one of an inner direction or an outer direction of the temple, the rear region has a groove portion that is recessed from one surface toward the other surface of the temple in an up-down direction and penetrates the temple in an in-out direction, and a recess portion that is disposed on an outer side surface of the temple, is recessed in the inner direction of the temple, and communicates with the groove portion, and the pair of temples are configured such that the groove portion of the rear region of one temple is fitted into a portion of the front region of the other temple that is closer to the front side than the protrusion portion and are further slid along the front region to a protrusion portion side, and thus the protrusion portion of the other temple is accommodated in the recess portion of the one temple.

According to the present aspect, since the protrusion portion of the other temple is accommodated in the recess portion of the one temple, when the temples are folded, it is possible to prevent the temples from being unintentionally disengaged from each other.

In the above-described aspect, the recess portion may have a top surface, a bottom surface, and a back surface, and an opening communicating with the groove portion may be formed between the top surface and the bottom surface.

In the above-described aspect, the recess portion may have a side surface on a side opposite to the opening.

In the above-described aspect, the recess portion may be configured such that the protrusion portion is movable in the recess portion.

In the above-described aspect, the recess portion may be configured to be fitted to the protrusion portion.

In the above-described aspect, the protrusion portion may have a triangular prism shape having a triangular shape in a top view of the temple.

In the above-described aspect, the protrusion portion protrudes only in the inner direction of the temple and has a length in the up-down direction that is the same as or shorter than a length of the temple in the up-down direction.

According to the present invention, when a pair of temples of the hingeless eyewear is locked to each other and folded, it is possible to prevent that one temple is unintentionally disengaged from the other temple, and particularly, when an external force is applied to the locking portion in an up or down direction, it is possible to prevent that the temple folded state is easily released by disengagement of the locking. Furthermore, it is possible to provide a hingeless eyewear having a sophisticated design with a simple and natural shape in which a locking structure between the temples is not likely to be conspicuous.

### BRIEF DESCRIPTION OF DRAWINGS

FIG. 1 is a perspective view for describing an example of a configuration of an eyewear.

FIG. 2 is a top view for describing an example of the configuration of the eyewear.

FIG. 3 is a side view for describing an example of the configuration of the eyewear.

FIG. 4 is a view for describing an example of a configuration of a protrusion portion of a temple of the eyewear.

FIG. 5 is a view for describing an example of a configuration of a groove portion and a recess portion of the temple.

FIG. 6 is a view for describing an example of a state where one temple is bent inward.

FIG. 7 is a view for describing an example of a state where a groove portion of one temple is fitted to the other temple.

FIG. 8 is a view for describing an example of a state where a protrusion portion of one temple is accommodated in a recess portion of the other temple.

FIG. 9 is a view for describing an example of a state where the temple of the eyewear is folded.

FIG. 10 is a view for describing another configuration example of the recess portion and the protrusion portion of the temple.

### DETAILED DESCRIPTION

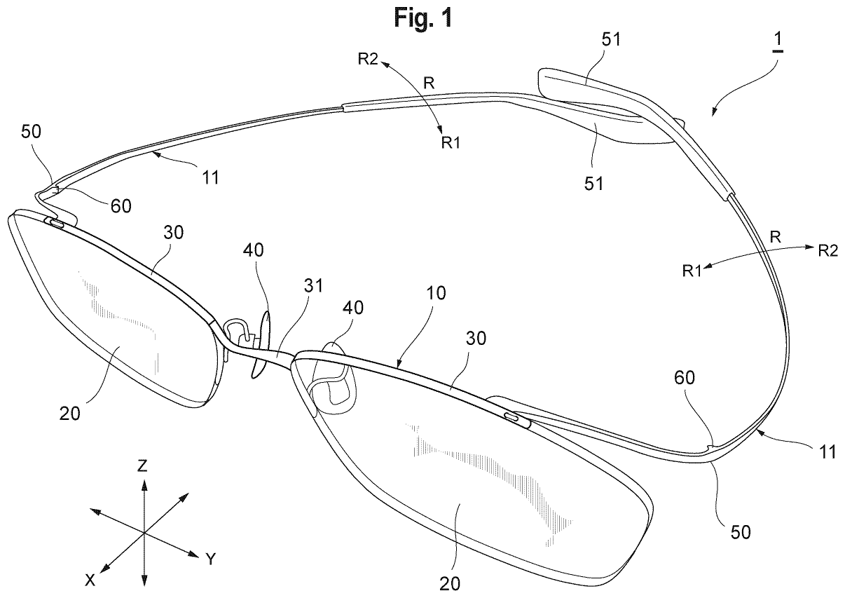

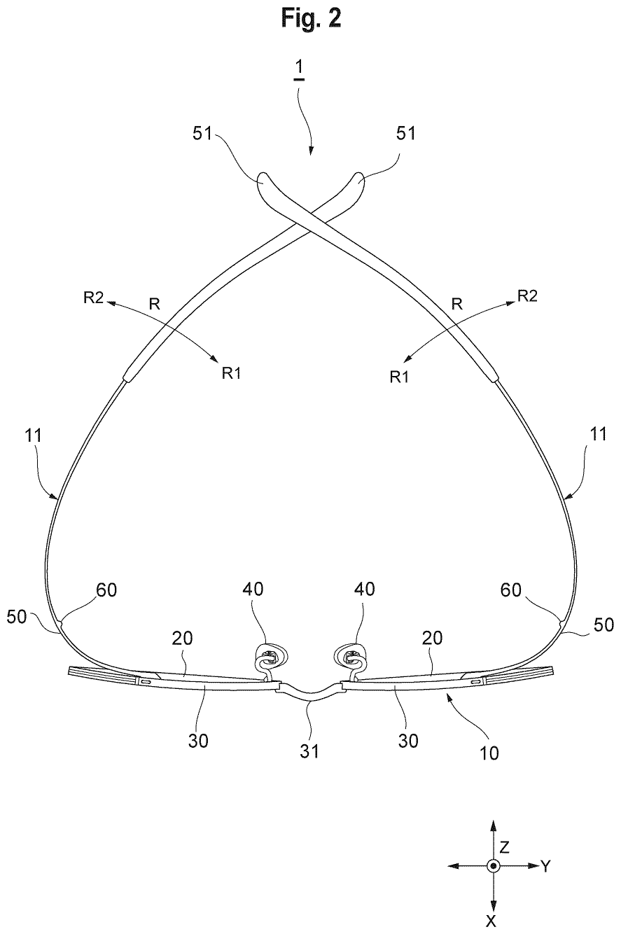

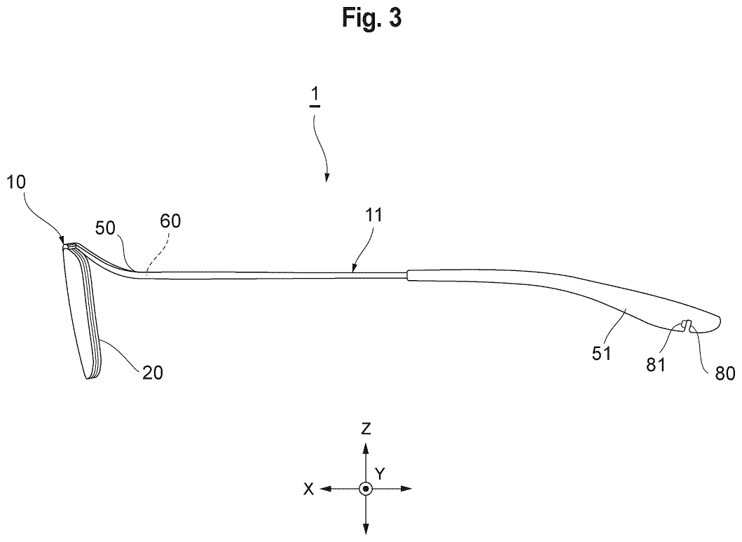

Hereinafter, preferred embodiments according to the present invention will be described with reference to the drawings. FIG. 1 is a perspective view for describing an example of a configuration of an eyewear 1. FIG. 2 is a top view for describing an example of the configuration of the eyewear 1. FIG. 3 is a side view for describing an example of the configuration of the eyewear 1. In the present specification, a front and rear of the eyewear 1 coincide with a front and rear of a head portion of a wearer when the eyewear 1 is worn, and a front 10 side is referred to as a front as viewed from a temple 11 described later and a temple 11 side is referred to as a rear as viewed from a front 10. Upper and lower parts of the eyewear 1 coincide with upper and lower parts of the head portion of the wearer when the wearer wears the eyewear 1. In addition, a head portion side of the wearer is set as an inside with respect to the temple 11, and a side opposite to the head portion of the wearer is set as an outside with respect to the temple 11. A direction perpendicular to and horizontal to a front-rear direction of the front 10 is referred to as a left-right direction.

As illustrated in FIGS. 1 and 2, in one embodiment, the eyewear 1 includes the front 10 and a pair of temples 11.

In one embodiment, the front 10 is configured to support a pair of lenses 20 side by side in a left-right direction Y. The front 10 has a pair of lens holding portions 30 that hold the left and right lenses 20, and a connecting portion (bridge) 31 that connects the pair of lens holding portions 30 to each other. The connecting portion 31 is located at a center of the front 10 in the left-right direction Y, and the front 10 is configured to be left-right symmetrical with the connecting portion 31 as the center. The front 10 further includes a nose pad 40 that touches the nose of the wearer for support.

As illustrated in FIGS. 1 to 3, the temple 11 is configured to be hung on an ear of the wearer. Each temple 11 is connected to the lens holding portion 30 of the front 10. Each temple 11 is connected to the front 10 in a hingeless manner not to include a hinge structure having a rotation axis.

The temple 11 has flexibility. The temple 11 may be made of metal or resin. The temple 11 has an elongated shape that is long in a front-rear direction X. The temple 11 may have a rectangular cross-sectional shape having thicknesses in an up-down direction Z and an in-out direction R. The dimension of the temple 11 in the up-down direction Z may be larger than the dimension in the in-out direction R. The temple 11 may have a curved shape that gradually curves inward toward a rear end.

The temple 11 has a front region 50 located on the front 10 side and a rear region 51 located on a rear end side opposite to the front 10 side.

The front region 50 constitutes a hingeless folded portion not to include a hinge structure having a rotation axis between the front 10 and the front region 50. The front region 50 has a protrusion portion 60 that protrudes in at least one of an inner direction R1 or an outer direction R2 of the temple 11. In one embodiment, the protrusion portion 60 protrudes only in the inner direction R1 of the temple 11.

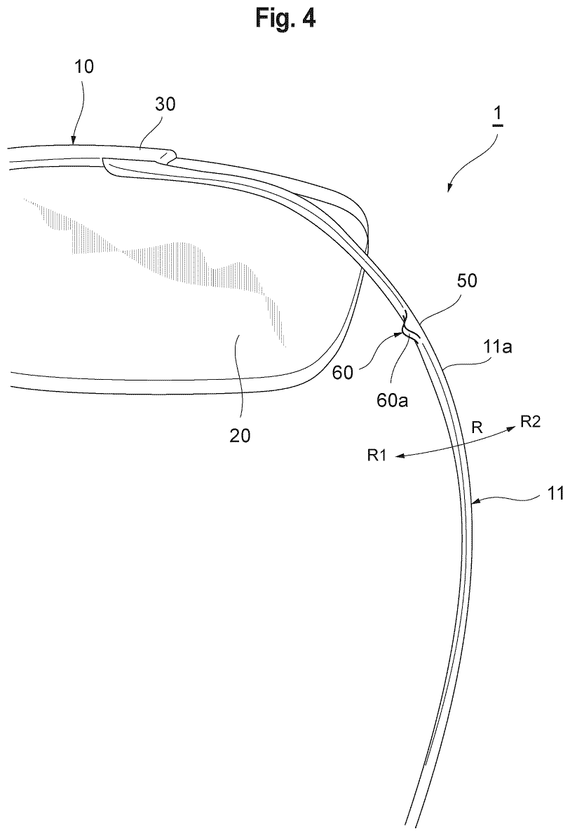

As illustrated in FIG. 4, the protrusion portion 60 has a substantially triangular prism shape having a substantially triangular shape in a top view of the temple 11. The protrusion portion 60 has an inner surface 60a that smoothly protrudes inward from a temple main body 11a. That is, the inner surface 60a of the protrusion portion 60 is smoothly and continuously connected to an inner surface (inner surface of the temple main body 11a) front and rear of the temple 11 without a step.

The protrusion portion 60 has a length in the up-down direction Z the same as or shorter than that of the temple main body 11a. Therefore, as illustrated in FIG. 3, when the eyewear 1 is observed from the outside (a left side as viewed from the wearer in FIG. 3), the protrusion portion 60 is hidden by the temple main body 11a and cannot be visually recognized.

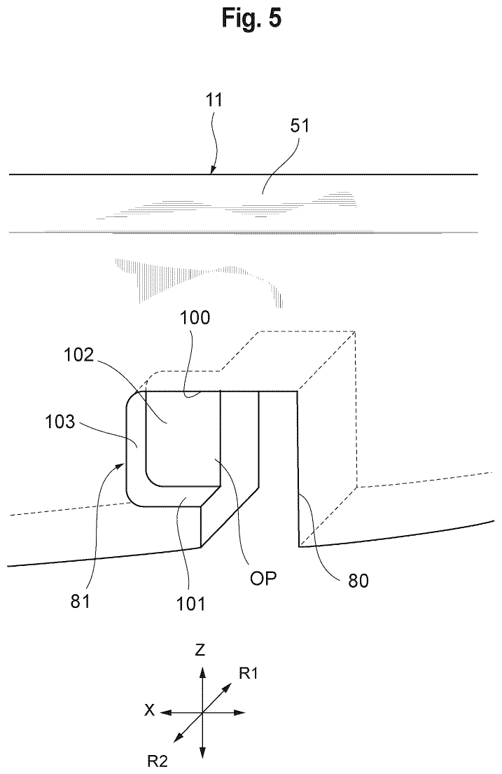

As illustrated in FIGS. 3 and 5, the rear region 51 has a groove portion 80 and a recess portion 81. The groove portion 80 is recessed from one surface toward the other surface of the temple 11 in the up-down direction Z and penetrates the temple 11 in the in-out direction R. In one embodiment, the groove portion 80 is recessed from the lower surface toward the upper surface. The groove portion 80 is configured to be fitted from above with respect to the front region 50 of the temple 11.

The recess portion 81 is disposed on the outer side surface of the temple 11 and is recessed in the inner direction R1. The recess portion 81 communicates with the groove portion 80. The recess portion 81 is disposed adjacent to the front side (foreside) of the groove portion 80 in the temple 11. The recess portion 81 is configured to accommodate the protrusion portion 60.

The recess portion 81 has a top surface 100, a bottom surface 101, and a back surface 102. An opening OP communicating with the groove portion 80 is formed between the top surface 100 and the bottom surface 101 of the recess portion 81. The recess portion 81 has a side surface 103 on a side opposite to the opening OP.

The recess portion 81 is configured such that the protrusion portion 60 is movable in the recess portion 81 in a state of being accommodated in the recess portion 81. The recess portion 81 may have dimensions larger than those of the protrusion portion 60 in the up-down direction Z and the front-rear direction X. The recess portion 81 may have a dimension larger than that of the protrusion portion 60 in the in-out direction R. The recess portion 81 and the protrusion portion 60 may be configured to have a size in which the protrusion portion 60 is completely accommodated in the recess portion 81, or may be configured to have a size in which a part of the protrusion portion 60 is accommodated in the recess portion 81. The temple 11 may have a temple tip portion made of resin or rubber in the rear region 51, and the temple tip portion may have the groove portion 80 and the recess portion 81.

The pair of temples 11 are configured such that the groove portion 80 of the rear region 51 of one temple 11 is fitted into a portion of the front region 50 of the other temple 11 on the front 10 side of the protrusion portion 60 and is further slid along the front region 50 to the protrusion portion 60 side, so that the protrusion portion 60 of the other temple 11 is accommodated in the recess portion 81 of the one temple 11. That is, the eyewear 1 is able to perform a folding operation of the temple 11 as follows.

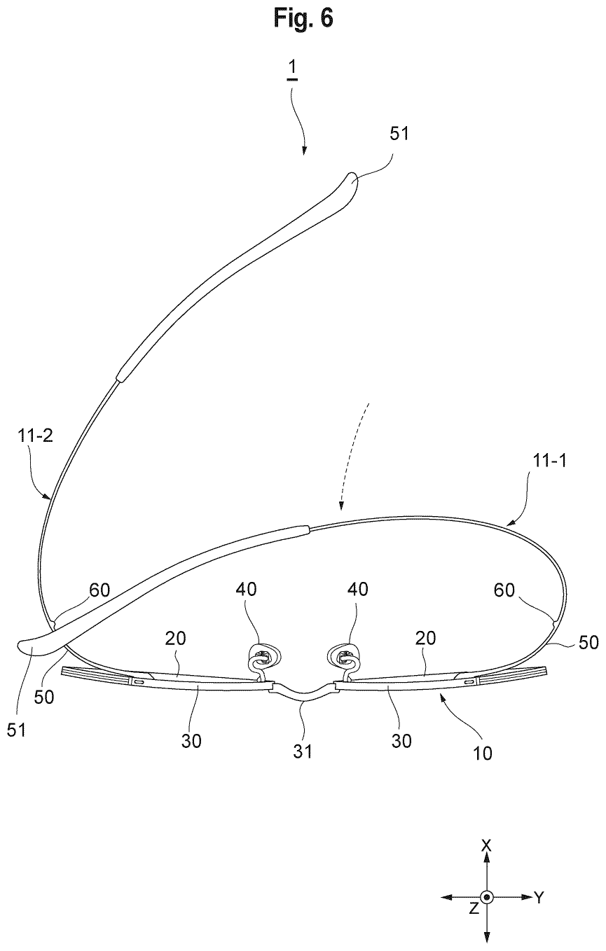

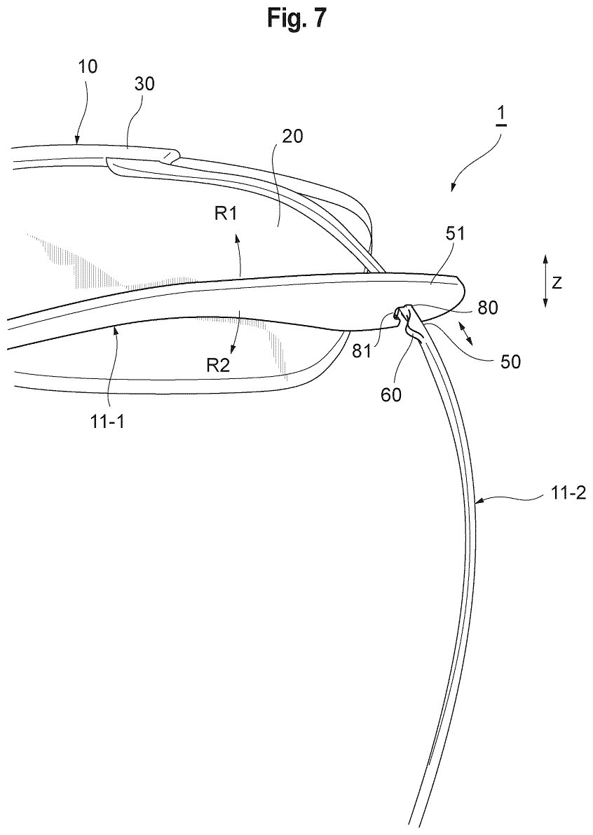

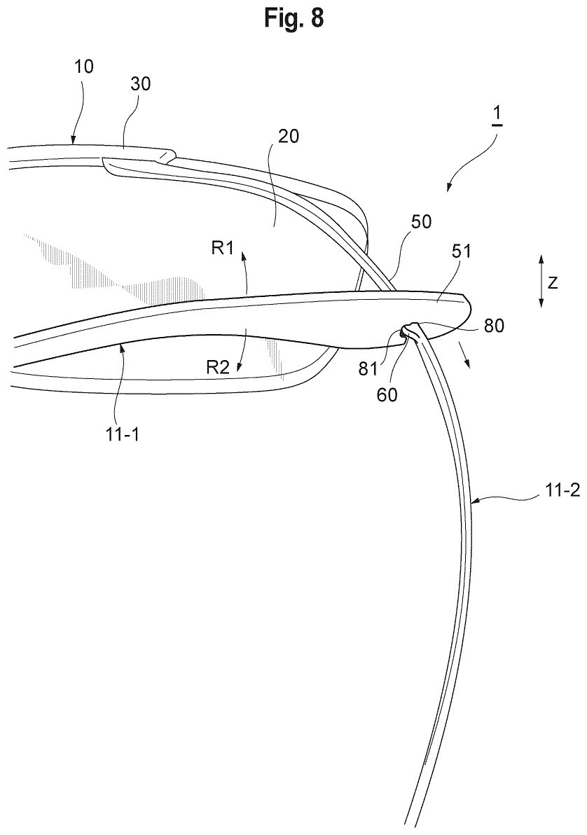

When the temple 11 of the eyewear 1 is folded, first, as illustrated in FIG. 6, a first temple 11-1 is largely bent inward. Then, as illustrated in FIG. 7, the groove portion 80 of the rear region 51 of the first temple 11-1 is fitted into a portion of the front region 50 of a second temple 11-2 that is closer to the front 10 side than the protrusion portion 60. In this case, a restoring force (elastic force) in the outer direction R2 acts on the first temple 11-1 due to the flexibility of the first temple 11-1. Next, as illustrated in FIG. 8, the rear region 51 of the first temple 11-1 is slid to the protrusion portion 60 side along the front region 50 of the second temple 11-2, and the protrusion portion 60 of the second temple 11-2 is accommodated in the recess portion 81 of the first temple 11-1. In this case, the protrusion portion 60 of the second temple 11-2 and the back surface 102 of the recess portion 81 of the first temple 11-1 abut against each other due to the restoring force of the first temple 11-1. In addition, the movement of the protrusion portion 60 of the second temple 11-2 in the up-down direction Z is restricted by the top surface 100 and the bottom surface 101 of the recess portion 81 of the first temple 11-1. Accordingly, the rear region 51 of the first temple 11-1 is locked to the front region 50 of the second temple 11-2.

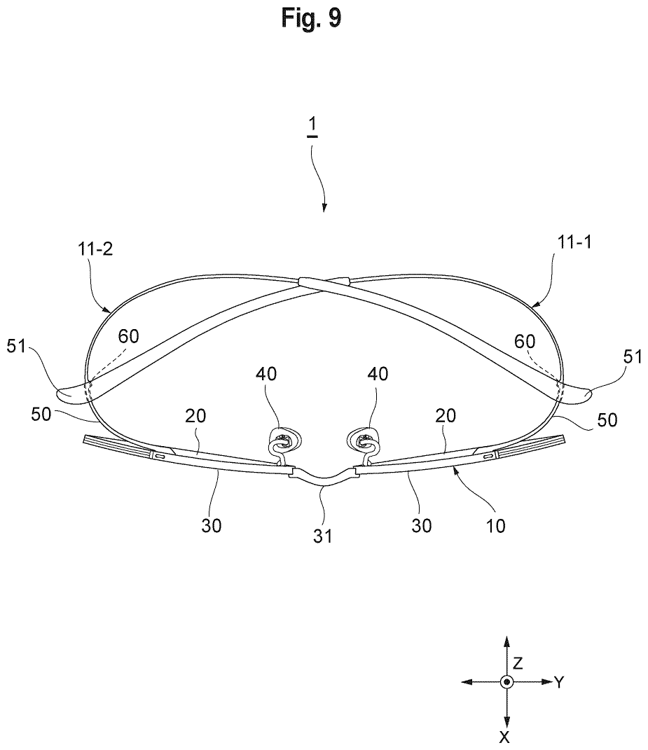

Next, similarly, in the second temple 11-2, the second temple 11-2 is largely bent inward, and the groove portion 80 of the rear region 51 of the second temple 11-2 is fitted into a portion of the front region 50 of the first temple 11-1 that is closer to the front 10 side than the protrusion portion 60. Next, the rear region 51 of the second temple 11-2 is slid to the protrusion portion 60 side along the front region 50 of the first temple 11-1, and the protrusion portion 60 of the first temple 11-1 is accommodated in the recess portion 81 of the second temple 11-2. The protrusion portion 60 of the first temple 11-1 and the back surface 102 of the recess portion 81 of the second temple 11-2 abut against each other due to the restoring force of the second temple 11-2. In addition, the movement of the protrusion portion 60 of the first temple 11-1 in the up-down direction Z is restricted by the top surface 100 and the bottom surface 101 of the recess portion 81 of the second temple 11-2. Accordingly, the rear region 51 of the second temple 11-2 is locked to the front region 50 of the first temple 11-1. In this way, as illustrated in FIG. 9, the temple 11 (temple 11-1 and temple 11-2) of the eyewear 1 is folded.

When the temple 11 of the eyewear 1 is opened, as illustrated in FIG. 7, the groove portion 80 of the rear region 51 of the first temple 11-1 is slid to the front 10 side (the inner direction R1) along the front region 50 of the second temple 11-2, and the protrusion portion 60 of the second temple 11-2 is taken out from the recess portion 81 of the first temple 11-1. Next, the groove portion 80 of the first temple 11-1 is moved upward with respect to the front region 50 of the second temple 11-2 to remove the first temple 11-1 from the second temple 11-2. Accordingly, the locking between the rear region 51 of the first temple 11-1 and the front region 50 of the second temple 11-2 is released.

Similarly, in the second temple 11-2, the groove portion 80 of the rear region 51 in the second temple 11-2 is slid to the front 10 side along the front region 50 of the first temple 11-1, and the protrusion portion 60 of the first temple 11-1 is taken out from the recess portion 81 of the second temple 11-2. Next, the groove portion 80 of the second temple 11-2 is moved upward with respect to the front region 50 of the first temple 11-1 to remove the second temple 11-2 from the first temple 11-1. Accordingly, the locking between the rear region 51 of the second temple 11-2 and the front region 50 of the first temple 11-1 is released.

According to the present embodiment, in the hingeless eyewear 1, the front region 50 of the temple 11 has the protrusion portion 60 that protrudes in the inner direction R1 of the temple 11, and the rear region 51 has the groove portion 80 that is recessed from the lower surface toward the upper surface of the temple 11 in the up-down direction Z and penetrates the temple 11 in the in-out direction R, and the recess portion 81 that is disposed on the outer side surface of the temple 11, is recessed in the inner direction R1 of the temple 11, and communicates with the front side (foreside) of the groove portion 80. The pair of temples 11 is configured such that the groove portion 80 of the rear region 51 of one temple 11 is fitted into a portion of the front region 50 of the other temple 11 that is closer to the front 10 side than the protrusion portion 60 and is further slid along the front region 50 to the protrusion portion 60 side, so that the protrusion portion 60 of the other temple 11 is accommodated in the recess portion 81 of the one temple 11. Accordingly, when the pair of temples 11 of the eyewear 1 are locked to each other and folded, it is possible to prevent that one temple 11 is unintentionally disengaged from the other temple 11, particularly, when an external force is applied upward to the locking portion, it is possible to prevent that the temple folded state is easily released by disengagement of the locking. In addition, since the protrusion portion 60 is accommodated in the recess portion 81, the temples 11 are locked to each other. Therefore, the locking mechanism is simple, and the appearance of the locked state is also simple. As a result, it is also possible to realize an eyewear with a sophisticated design of a simple and natural shape in which a locking structure between the temples is not likely to be conspicuous.

The recess portion 81 has the top surface 100, the bottom surface 101, and the back surface 102, and the opening OP communicating with the groove portion 80 is formed between the top surface 100 and the bottom surface 101. As a result, the movement of the protrusion portion 60 is restricted by the three surfaces of the recess portion 81, that is, the top surface 100, the bottom surface 101, and the back surface 102, and in particular, the back surface 102 of the recess portion 81 of one temple 11 is pressed and abuts against the protrusion portion 60 of the other temple 11 by the restoring force of one temple 11, so that the locking is made reliable and the unintentional disengagement can be further prevented.

The recess portion 81 has a side surface 103 on a side opposite to the opening OP. Accordingly, the movement of the protrusion portion 60 is restricted by the four surfaces of the recess portion 81, that is, the top surface 100, the bottom surface 101, the back surface 102, and the side surface 103, and it is possible to further prevent the unintentional disengagement of one temple 11 from the other temple 11.

The recess portion 81 is configured such that the protrusion portion 60 is movable in the recess portion 81. Accordingly, the protrusion portion 60 is easily accommodated in the recess portion 81. In addition, since the protrusion portion 60 is allowed to move in the recess portion 81, in other words, since there is a clearance in the locked state, even if an external force is applied to the locking portion and the locking portion is slightly deformed, it is possible to prevent the temples 11 from being disengaged from each other.

The protrusion portion 60 has a triangular prism shape having a triangular shape in a top view of the temple 11. Accordingly, when the recess portion 81 is moved from the front 10 side to the protrusion portion 60 side, the protrusion portion 60 is able to be smoothly locked.

The protrusion portion 60 protrudes only in the inner direction R1 of the temple 11 and has a length in the up-down direction Z that is the same as or shorter than a length of the temple 11 in the up-down direction Z. Accordingly, since the protrusion portion 60 does not protrude from the outside of the temple 11 in the up-down direction, it is possible to prevent the protrusion portion 60 from coming into contact with or being hooked by surrounding members during the operation or wearing of the eyewear 1. In addition, since the protrusion portion 60 is not easily seen from the outside, the designability of the hingeless eyewear 1 having a simple and natural shape is improved.

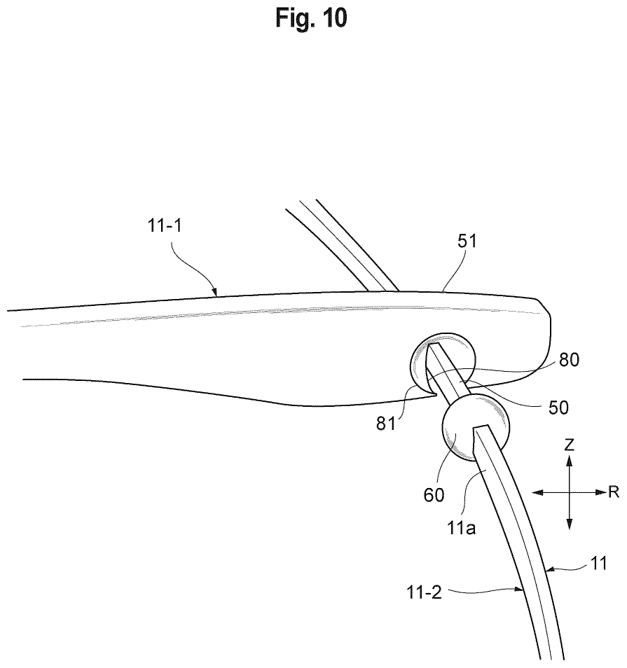

In the above-described embodiment, the recess portion 81 may be configured to be fitted to the protrusion portion 60. For example, as illustrated in FIG. 10, the protrusion portion 60 may have a spherical protrusion shape that protrudes in the up-down direction Z and the in-out direction R of the temple main body 11a in the front region 50 of the temple 11 (11-2). The recess portion 81 may have a hemispherical recess shape that is fitted to the protrusion portion 60 of the other temple 11-2 in the rear region 51 of the temple 11 (11-1). The recess portion 81 and the protrusion portion 60 may have radii of the same size. The recess portion 81 may be formed such that the groove portion 80 is surrounded on the outer side surface of the temple 11 (11-1). The protrusion portion 60 and the recess portion 81 may be fitted to each other by pushing the recess portion 81 into the protrusion portion 60. In such a case, it is possible to prevent the protrusion portion 60 from being disengaged from the recess portion 81.

The eyewear 1 is not limited to the configuration described in the above-described embodiment. The structure, shape, size, and the like of the front 10 and the temple 11 are not limited to those of the above-described embodiment. The recess portion 81 and the protrusion portion 60 may have other shapes (for example, a quadrangular prism shape instead of the triangular prism shape) or sizes as long as the protrusion portion 60 is able to be accommodated in the recess portion 81.

In the above-described one embodiment, the protrusion portion 60 protrudes only in the inner direction R1 of the temple 11, but may protrude only in the outer direction R2. In this case, the recess portion 81 of the temple 11 may be disposed adjacent to a side (rear side) of the groove portion 80 of the temple 11 opposite to the front. In addition, the protrusion portion 60 may protrude in both the inner direction R1 and the outer direction R2 of the temple 11. The groove portion 80 is recessed from the lower surface toward the upper surface of the temple 11, but may be recessed from the upper surface toward the lower surface of the temple 11. In this case, the groove portion 80 of one temple 11 may be fitted into the front region 50 of the other temple 11 from below, and then slid along the front region 50 to the protrusion portion 60 side to accommodate the protrusion portion 60 in the recess portion 81. In this case, even when an external force is applied in the down direction to the locking portion, it is possible to prevent that the temple folded state is easily released by disengagement of the locking.

The present disclosure is able to include, for example, the following configurations.

### (Addendum 1)

An eyewear including:
a front; and
a pair of temples connected to the front in a hingeless manner not to include a hinge structure having a rotation axis and having flexibility, in which
each of the temples has a front region on a front side and a rear region on a rear end side opposite to the front side,
the front region has a protrusion portion that protrudes in at least one of an inner direction or an outer direction of the temple,
the rear region has
a groove portion that is recessed from one surface toward the other surface of the temple in an up-down direction and penetrates the temple in an in-out direction, and
a recess portion that is disposed on an outer side surface of the temple, is recessed in the inner direction of the temple, and communicates with the groove portion, and
the pair of temples are configured such that the groove portion of the rear region of one temple is fitted into a portion of the front region of the other temple that is closer to the front side than the protrusion portion and are further slid along the front region to a protrusion portion side, and thus the protrusion portion of the other temple is accommodated in the recess portion of the one temple.

### (Addendum 2)

The eyewear according to Addendum 1, in which the recess portion has a top surface, a bottom surface, and a back surface, and an opening communicating with the groove portion is formed between the top surface and the bottom surface.

### (Addendum 3)

The eyewear according to Addendum 2, in which the recess portion has a side surface on a side opposite to the opening.

### (Addendum 4)

The eyewear according to any one of Addenda 1 to 3, in which the recess portion is configured such that the protrusion portion is movable in the recess portion.

### (Addendum 5)

The eyewear according to any one of Addenda 1 to 3, in which the recess portion is configured to be fitted to the protrusion portion.

### (Addendum 6)

The eyewear according to any one of Addenda 1 to 5, in which the protrusion portion has a triangular prism shape having a triangular shape in a top view of the temple.

### (Addendum 7)

The eyewear according to any one of Addenda 1 to 6, in which the protrusion portion protrudes only in the inner direction of the temple and has a length in the up-down direction that is the same as or shorter than a length of the temple in the up-down direction.

In the above-described exemplary embodiments, the eyewear is able to be variously modified without departing from the scope and gist of the present disclosure. For example, some components in one embodiment are able to be added to another embodiment within the range of the ordinary creativity of those skilled in the art. In addition, some components in one embodiment are able to be replaced with corresponding components in another embodiment.

### INDUSTRIAL APPLICABILITY

In the present invention, when a pair of temples of the hingeless eyewear is locked to each other and folded, it is possible to prevent that one temple is unintentionally disengaged from the other temple, and particularly, when an external force is applied to the locking portion in an up or down direction, and it is possible to prevent that the temple folded state is easily released by disengagement of the locking. Furthermore, the present invention is useful when providing a hingeless eyewear having a sophisticated design with a simple and natural shape in which a locking structure between the temples is not likely to be conspicuous.

What is claimed is:

1. An eyewear comprising:
a front; and
a pair of temples connected to the front in a hingeless manner not to include a hinge structure, the hinge structure having a rotation axis, and the pair of temples having flexibility, wherein
each of the temples has a front region on a front side and a rear region on a rear end side opposite to the front side,
the front region has a protrusion portion that protrudes in at least one of an inner direction or an outer direction of the temple,
the rear region has
a groove portion that is recessed from one surface toward the other surface of the temple in an up-down direction and penetrates the temple in an in-out direction, and
a recess portion that is disposed on an outer side surface of the temple, is recessed in the inner direction of the temple, and communicates with the groove portion, and
the pair of temples are configured such that the groove portion of the rear region of one temple is fitted into a portion of the front region of the other temple that is closer to the front side than the protrusion portion and are further slid along the front region to a protrusion portion side, and thus the protrusion portion of the other temple is accommodated in the recess portion of the one temple.

2. The eyewear according to claim 1, wherein
the recess portion has a top surface, a bottom surface, and a back surface, and an opening communicating with the groove portion is formed between the top surface and the bottom surface.

3. The eyewear according to claim 2, wherein
the recess portion has a side surface on a side opposite to the opening.

4. The eyewear according to claim 1, wherein
the recess portion is configured such that the protrusion portion is movable in the recess portion.

5. The eyewear according to claim 1, wherein
the recess portion is configured to be fitted to the protrusion portion.

6. The eyewear according to claim 1, wherein
the protrusion portion has a triangular prism shape having a triangular shape in a top view of the temple.

7. The eyewear according to claim 1, wherein
the protrusion portion protrudes only in the inner direction of the temple and has a length in the up-down direction that is the same as or shorter than a length of the temple in the up-down direction.

8. The eyewear according to claim 6, wherein
the protrusion portion protrudes only in the inner direction of the temple and has a length in the up-down direction that is the same as or shorter than a length of the temple in the up-down direction.
